(19) United States
(12) Patent Application Publication
(10) Pub. No.: US 2019/0264462 A1
(43) Pub. Date: Aug. 29, 2019

(54) MEMORIAL SUITE AND A MULTI-FLOOR BUILDING STRUCTURE FOR HOUSING SAME

(71) Applicant: Gary Green, Penn Valley, PA (US)

(72) Inventor: Gary Green, Penn Valley, PA (US)

(21) Appl. No.: 15/903,780

(22) Filed: Feb. 23, 2018

(51) Int. Cl. E04H 13/00; A61G 17/02; A61G 17/04; A61G 17/08

(52) U.S. Cl. CPC E04H 13/006; E04H 13/001; A61G 17/08; A61G 17/044; A61G 17/048; A61G 17/02

(57) ABSTRACT

A memorial suite provides a safe and comfortable place for surviving family members, friends, and loved ones to mourn, research and visit decedents. The memorial suite takes advantage of air space rather than burying caskets containing human remains in the ground. A storage area is provided within the memorial suite that includes horizontal shelves that support receptacles thereon. Each receptacle is provided for storing interment vessels or air-tight caskets containing remains of the decedent. A tribute wall may include plaques bearing images and descriptive information about the decedents. The memorial suite may include some or all of the comforts of a living room and other rooms within a family home.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### INCORPORATION-BY-REFERENCE OF MATERIAL SUBMITTED ON A COMPACT DISK

“Not Applicable”

### FIELD OF THE INVENTION

This invention relates to an expandable, memorial room or suite, cluster of rooms, and dedicated floors and buildings that provides a safe, private and comfortable place for surviving family members, associates in a group, friends, and loved ones to mourn, research and visit an assembly of decedents, where the number of those interred in the memorial suite is expected to grow over time.

### BACKGROUND OF THE INVENTION

Burial in the ground is the ritual act of placing a dead person, e.g., a family member or loved one, into the ground. This is accomplished by excavating a pit or trench, placing the deceased in it, and covering it over. Burial in the ground is often seen as indicating respect for the dead. Burial in the ground has been used to prevent the odor of decay, to give family members closure and prevent them from witnessing the decomposition of their loved ones. In many cultures burial or interment has been seen as a necessary step for the deceased to enter the afterlife or to give back to the cycle of life.

Traditional burials occur on land specifically designated as a burial ground often referred to as a cemetery. Cemetery lots are set apart for containing graves, tombs, or funeral urns. In Western cultures, funeral ceremonies are often observed in cemeteries.

There are several disadvantages to traditional burials and funerals. First, the structured formality of the traditional funeral service may not provide the family with a sense of comfort and closure. Many may not believe the traditional cemetery or funeral service provides a way to adequately celebrate the life of the deceased. Many also may feel that the traditional cemetery and funeral services lack meaning. Also, to many, visiting a cemetery to spend time with a deceased family member or loved one can be a negative experience. On the other hand, for the living who might be contemplating what circumstances will prevail when they too die, traditional burial or cremation deprives them of any confidence that their descendants (and others whose opinions they care about) will ever learn about their biography, will remember what they deem important aspects of their existence, personality, accomplishments, interests, how they fit into their contemporary world; and critically, whether their descendants will even know of their existence. To the person thinking of what will happen after she or he dies, these factors destroy the prospect of the virtual immortality many people hope they will enjoy by being remembered. This adds another layer of foreboding many people associate with dying.

To elaborate, a visit to the cemetery may lack intimacy, as the surviving family may be surrounded by strangers in close proximity, also there to pay respects to their deceased family members and loved ones. In addition, as cemeteries are usually outdoors, scheduled visits often coincide with inclement weather conditions such as hot sun, rain, snow, or cold weather, thus making the visit an unpleasant experience. Also, for many, looking at a stone marker indicating the burial place of a departed loved one is an experience that is devoid of meaning and bearing no relation to the memory of a deceased family member or friend. Also, it is often the case that the location of the cemetery is dictated by religious beliefs and other factors bearing no relation to where the departed lived or frequented. Often, the cemetery in which a deceased loved one is buried is located a long distance from family members making visits inconvenient. To many, traditional burials and memorials have become trite, expensive and lacking in shared experience.

As a result, due to these drawbacks and for other reasons, after a few years the deceased is often forgotten and family members no longer visit graves with any regularity or frequency. This reality is not because family members do not venerate the deceased family member or loved one, or because remaining family members are not sad or mournful. Rather, it is because the traditional cemetery can be a negative experience to many. Similarly, the negative emotional and lack of meaning factors associated with the traditional burial experience, apply as well to cremation.

Also, burying dead bodies in the ground and cremation are taxing on the environment. Toxic chemicals from the embalming, burial, and cremation processes leach into the air and soil, and expose funeral workers to potential hazards. Also, as the population continues to grow, cities and towns have scant available ground that economically, and from a community development standpoint would make a cemetery the best use of the land. The result is that now, and even more so in the future, there will be inadequate available burial space. Internationally, communities, religions and governments will thus have to manage with a shortage of cemetery plots in the future. This will substantially drive up the cost of traditional burials, on the one hand, and on the other hand, may ultimately deprive people who wish to conform to religious requirements, or their own scruples against cremation or other planned destruction of deceased bodies.

The present invention is designed to address all of the disadvantages, deficiencies and negatives associated with the current systems of burial. The invention avoids burial in a cemetery plot or on a single horizontal level, but rather, utilizes air space by arranging interment plots or interment suites vertically, thus conserving land formerly dedicated to the disposition of human remains. It also allows for the transmission of information about the life, lifestyle, hobbies, work, accomplishments, philosophy, biography, associations and anything else the deceased and his family wanted to be communicated to future generations or anyone else permitted to visit the deceased or provided with access to the information about the deceased. It allows for families and other groups to be reposed in a common room, an expandable room, or suite of rooms, where like a “Presidential Library,” a family or other group can start with a centralized museum and memorial to each current decedent, and within limits, over time, add new decedents with their own artifacts and information. In addition, the invention would likely have appeal to groups and people with a shared affinity. For example, the invention contemplates a place for veterans to be interred, such as a commemorative memorial suite, or set of suites for soldiers of a unit killed in a common war or attack, along with space reserved within the suite or suites for surviving members of the unit, which could also result in an entire building or community of buildings being used for veterans (on a scheme of affinity such as Arlington National Cemetery). Similarly, a city's first responders killed in the line of duty might be interred in their own memorial suite or buildings containing memorial suites for them (and possibly, their families). In both examples, the invention could be paid for and provided by the military or city organization (police/fire departments, etc.) as a benefit to their members.

The invention also contemplates the creation of real-time recording—likely by way of a dedicated, convenient online application (app)—of an eventual decedent's life story. The eventual decedent would record or type, likely in journal or blog style, experiences thoughts, interactions, markers, style, and the current sights and sounds extant during the decedent's life that can be curated and edited into a documentary, testament, or other combination of audio, video and text-based message by the decedent while alive, or afterwards by family, friends or employees of the memorial suite of the present invention to be available as an autobiographical legacy that informs, enlightens, entertains and provides an ongoing connection to the decedent for future visitors and generations. Since the app would be hosted at an online cloud-based or similar storage facility, the information could be accessed anywhere there is an Internet connection. This app should engender new habits where people will plan ahead and conveniently collect information on a daily, weekly, monthly or other regular schedule (or as new experiences or thoughts occur) for the benefit of their families and friends, similar to how information is shared via Facebook or other social media. But a key and important difference would be that this app and the information it contains is private and available only to the future decedent and invited families, friends, colleagues, etc. As for affinity groups, as mentioned above, artifacts and souvenirs that help depict the fatal battles or events, along with personal information about the group members could be depicted in multimedia formats or documented in other communicative formats.

### SUMMARY OF THE INVENTION

An expandable, memorial room or suite, cluster of rooms, and dedicated floors and buildings (known collectively as “memorial suite”) provides a safe, private and comfortable place for surviving family members, associates in a group, friends, and loved ones to mourn, research and visit an assembly of decedents, where the number of those interred in the memorial suite is expected to grow over time. This growth or expansion could be the result of surviving family members who die at some point in the future, or could be the result of deceased relatives who, at the wishes of the memorial suite owners, may be disinterred and transferred to the memorial suite. The invention is intended to be disruptive both in how people mourn and interact with decedents, and how they plan for, and produce information, multi-media programs and artifacts concerning their lives for visitors who were their contemporaries, as well as future visitors. The memorial suite takes advantage of vertical air space rather than burying caskets containing human remains in the ground. A secure, enclosed storage area for bodies of decedents of a decedent is provided within the memorial suite that includes horizontal shelves that support receptacles thereon. Each receptacle is provided for storing the remains of the various decedents housed in the memorial suite.

A tribute wall, at the discretion of the decedents or the decedents' representatives, may include plaques, photographs, multi-media, such as videos, sound recordings, along with written material and interactive and entertaining games relating to the decedents, and media containing descriptive information and works by, depicting, describing or pertaining to the decedents' biographies and autobiographies. The information and idiosyncratic artifacts associated with the decedent's work, groups, interests, accomplishments, hobbies, and biography would be in various formats, and contain material as determined by the decedents or their representatives. In addition, compilations, edited and curated multimedia programs as well as access to documents and files relating to the decedents can be created to be viewed online at the situs of the memorial suites, or off-site via the dedicated online app on a smartphone, computer, tablet or other device connected to the Internet or a network; and video conferencing at the site of the memorial suites would allow funerals, unveilings and other events at the memorial suites to be broadcast to others for virtual attendance or remote monitoring.

The memorial suite would have locked doors, with entry allowed only by authorized people to insure privacy and security. They may include some or all of the comforts of a living room and other rooms within a family home, including pictures, mementoes, videos, voice recordings and other personal objects. Additionally, a private website or online application may be made available to still-living memorial suite purchasers and their families, which allows creation of and provides private access to recordings, videos, journals, pictures and other content related to a decedent. In addition, the audio/video/text-based autobiographies would be indexed and made available for visitors to the memorial suite or suites.

### DESCRIPTION OF THE DRAWINGS

FIG. 1 is a perspective view of a multi-floor building structure for containing one or more of the memorial suites of the present invention;

FIG. 2 is enlarged perspective view of the multi-floor building structure for containing one or more memorial suites of the present invention;

FIG. 3 is a representational view of the ground floor of the multi-floor building structure for containing one or more memorial suites of the present invention;

FIG. 4 is a representational view of a memorial suite located on an upper floor of the multi-floor building structure of the present invention;

FIG. 5 is a perspective view of the memorial suite located on a floor of the multi-floor building structure of the present invention;

FIG. 6 is an enlarged perspective view of the storage area and tribute wall portions of the memorial suite of the present invention;

FIG. 7 is a perspective view of an air-tight interment vessel of the present invention shown located within the receptacle of the present invention, the receptacle shown with its front face in the open position;

FIG. 8 is a perspective view of the interment vessel of the present invention with the end cap removed;

FIG. 9 is a cross-sectional view taken along line 9-9 of FIG. 7;

FIG. 10 is a cross-sectional view providing details of the one-way check valve disposed in the open position; and,

FIG. 11 is a perspective view of an alternative embodiment of the storage area and tribute wall portions of the memorial suite of the present invention.

### DETAILED DESCRIPTION OF THE PREFERRED EMBODIMENT

The particulars shown herein are by way of example and for purposes of illustrative discussion of the embodiments of the present invention only and are presented in the cause of providing what is believed to be the most useful and readily understood description of the principles and conceptual aspects of the present invention.

The invention is directed to a facility for interring corpses that provides a private, safe and comfortable place for families and friends to mourn, research and visit the departed, as well as providing easy mobility of the corpses in the event a family relocates. The facility provides protection from weather elements during mourning and avoids burying bodies in the ground taking advantage of available airspace. The facility may include appropriate heating, ventilation, and air conditioning (HVAC) systems depending on the climate of its location as well as water and electricity with separate utility meters for each memorial suite, and for the common areas. The facility and the memorial suites will be designed for expansion to accommodate future decedents as a family grows, or its needs change.

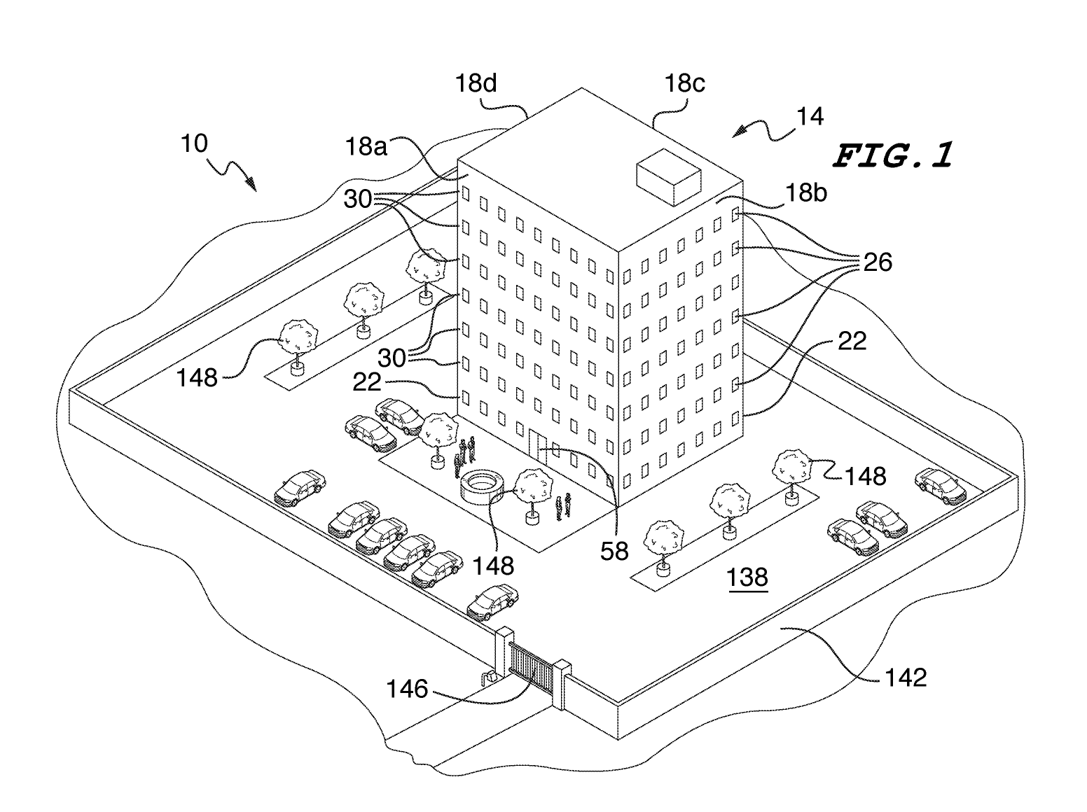

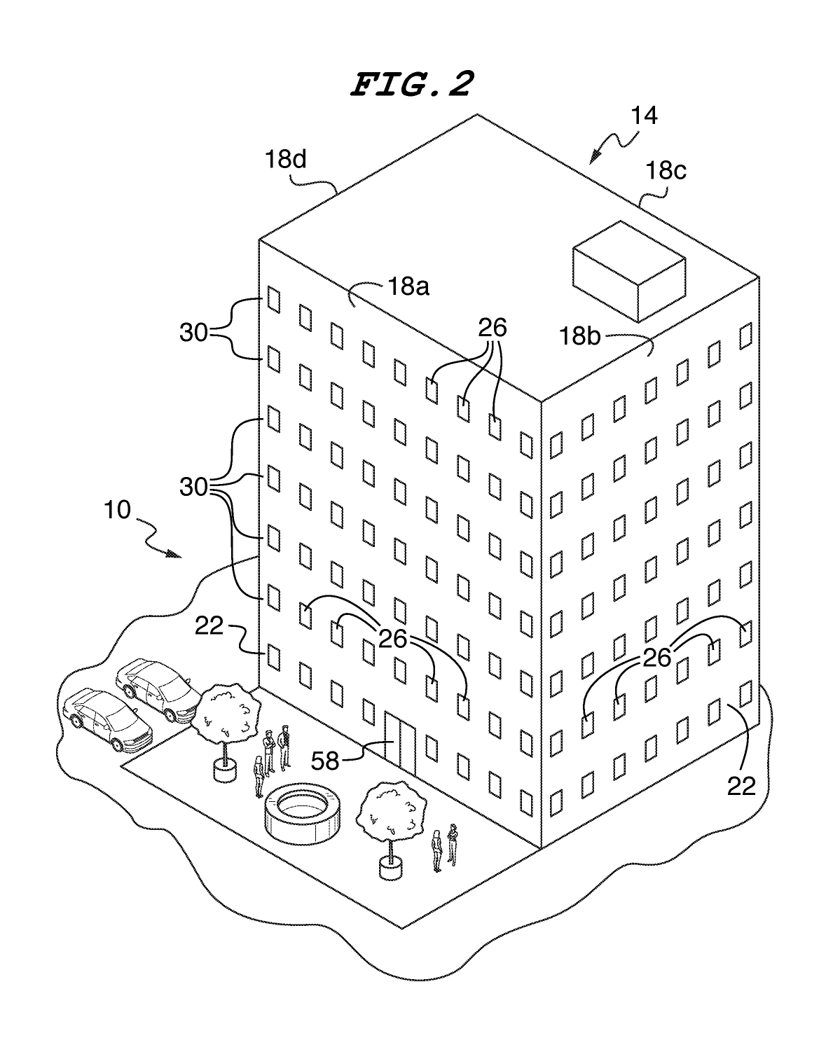

Referring now in greater detail to the drawings in which like numerals represent like components throughout the several views, there is shown in FIGS. 1 and 2, a facility 10 including a multi-floor building 14, e.g., seven floors in height. As best shown in FIGS. 1-3, the building 10 includes a ground floor 22, multiple upper floors 30 and by way of example, four exterior walls 18a, 18b, 18c and 18d. Each of the exterior walls 18a, 18b, 18c and 18d may include one or more windows 26 on the ground floor 22 and/or on the upper floors 30. Each of the upper floors 30 located above ground level is arranged to house one or more memorial suites to be discussed in detail below.

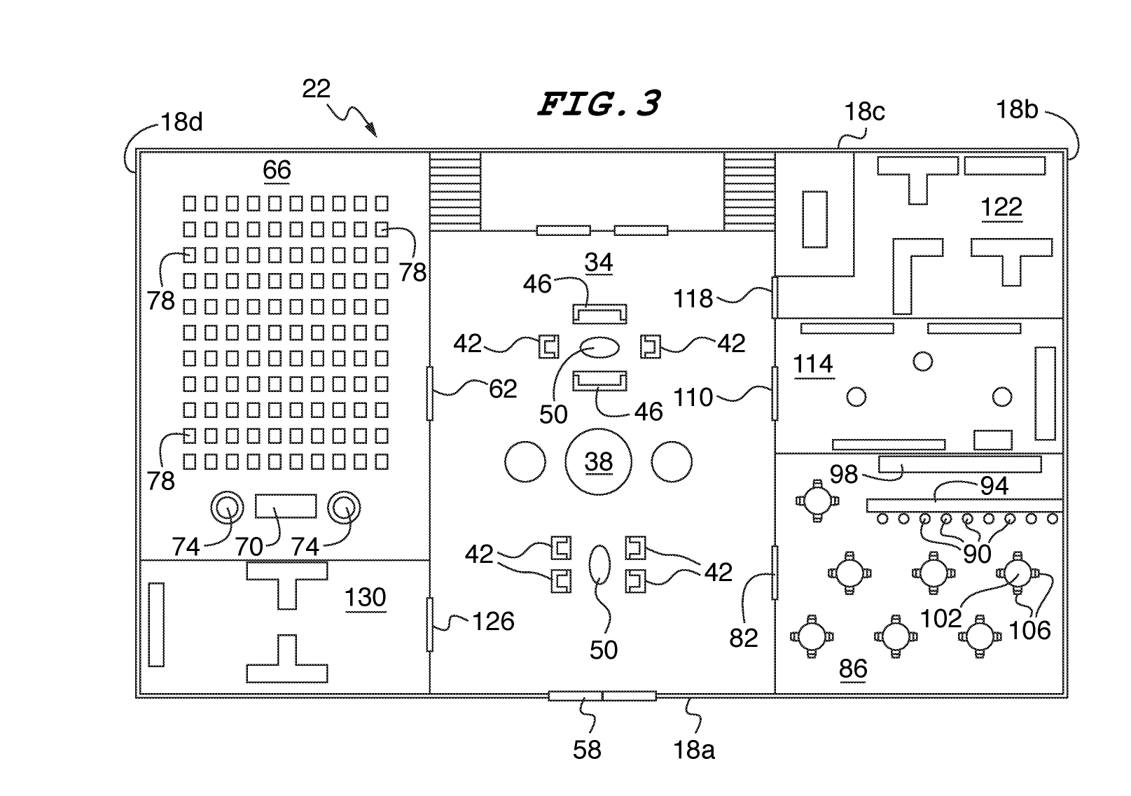

Referring now to FIG. 3, a representational view of the ground floor 22 portion of the multi-floor building 14 is shown. The ground floor portion 22 may be reserved for common areas such as a central lobby area 34. However, it should be understood that a common area, or any other areas depicted on the ground floor 22, are not required within the multi-floor building structure 14 and the ground floor portion 22 could be utilized for one or more memorial suites 134 as they are described below, or other purposes deemed necessary or desirable to the operations of the facility (for instance, a freight elevator used to move receptacles 218, furniture, etc.). The central lobby area 34 may include elements provided for the comfort and convenience of surviving family members, friends, and loved ones who are visiting a decedent, or for attendees of funeral or memorial services for the recently departed. Such elements may include a centrally-located decorative fountain 38, multiple chairs 42 and sofas 46 situated around low cocktail-height tables 50, and wall hangings (not shown). Also, the ground floor 22 may include stairways (not shown) and/or elevators (not shown) to provide access to memorial suites 134 located on the upper floors.

A doorway 58 provides access from the exterior of the building 14 to the central lobby area 34. A doorway 62 provides access from the lobby area 34 to a funeral parlor 66 where religious services such as funeral or memorial services may be led by a priest, rabbi, or other appropriate religious or secular official. The funeral parlor 66 includes a front area with floor space sufficient to accommodate a casket 70. Floor space is also provided at the front area of the funeral parlor 66 for display stands 74 for families of decedents who would like funeral flowers or mementoes to be displayed during a memorial or funeral service. Also provided within the funeral parlor 66 are rows of seats 78 sufficient in number to accommodate large groups for a funeral or memorial service. Exterior walls 18c and 18d of the funeral parlor 66 may include windows (not shown in FIG. 3) to allow sunlight to enter the funeral parlor 66. The facility may also store and make available various religious objects or decorations to accommodate the beliefs of the deceased and their families.

Another doorway 82 provides access from the lobby area 34 to a café 86, bistro, coffee shop or other facility for providing meals such as lunch, dinner or snacks to family members, friends, and loved ones visiting a decedent. The café 86 may also potentially be used or rented for post-funeral service gatherings and meals. The café 86 may include bar stools 90 positioned along the outside of a service counter 94. On the opposite side of the service counter 94 is a food preparation and service area including kitchen appliances and storage cabinetry 98. Additional guest seating for diners is provided including tables 102 and surrounding chairs 106 within the café 86.

Another doorway 110 provides access from the lobby area 34 to a flower/gift shop 114 possibly staffed by a professional florist where floral arrangements may be arranged and purchased by family members for use during a funeral or memorial service, or for display within the memorial suite 134.

Another doorway 118 provides access from the lobby area 34 to an administrative and security office 122 and another doorway 126 provides access from the lobby area 34 to an office space and storage area 130 located adjacent to the funeral parlor 66. The office space and storage area 130 is intended primarily to be for the use of funeral and/or facility 10 staff to prepare the deceased for viewing in a temporary casket, transfer the deceased from the temporary casket to an interment vessel 222 (FIGS. 6-8), etc. Other doorways (not shown) may be provided to enable access between the rooms of the ground floor 22, such as one leading from the office space and storage area 130 to the funeral parlor 66.

Referring now to FIG. 1, in addition to common areas located within the lobby area 34 of the multi-floor building 14, the facility 10 may include common areas located outside of the multi-floor building 14. Such exterior located common areas may include a parking lot 138, a security fence 142 surrounding the parking lot 138, and a motor-operated or guard-operated security gate 146 for controlling ingress and egress of visitors to the facility 10. Also, suitable landscaping including shrubbery and trees 148 and the like may be provided to create a pleasing aesthetic effect.

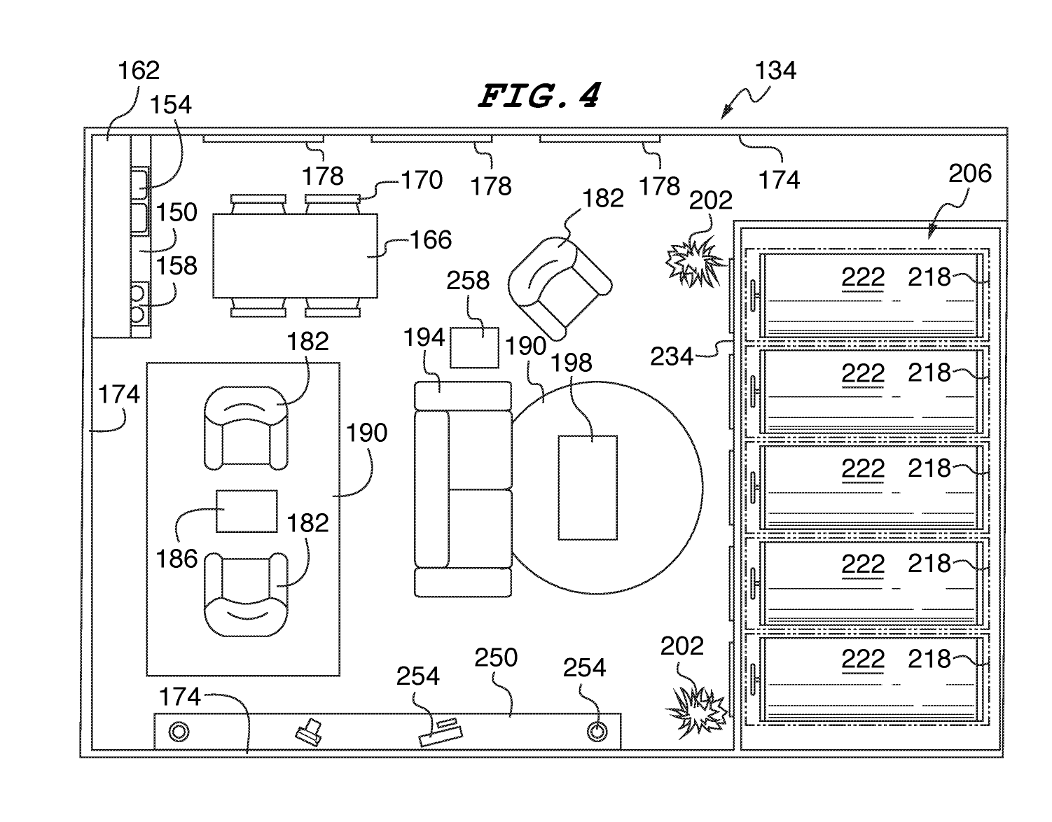

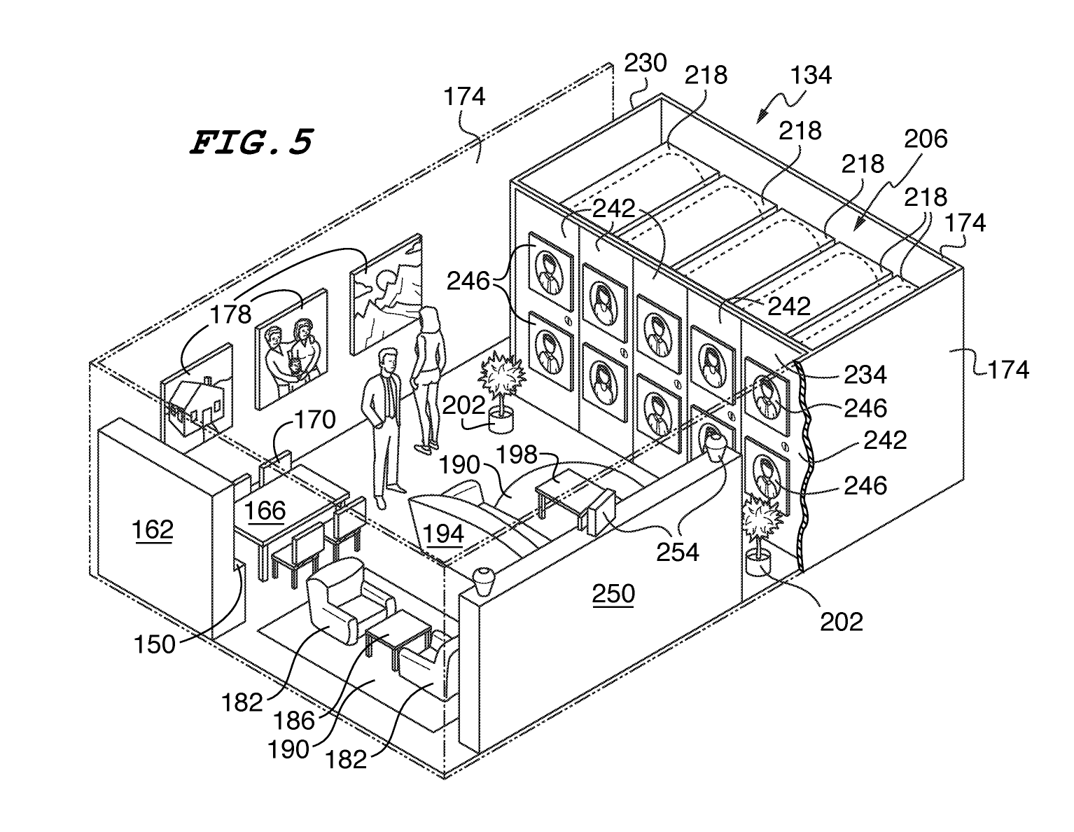

Referring to FIGS. 4 and 5 the details of the memorial suite 134, which may be located on the ground floor 22 or any upper floors 30 of the multi-floor building structure 14, are discussed. The memorial suite 134 is arranged to provide comfort, revive memories or impart information about the decedents, and identify things with which decedents were associated. For example, the memorial suites 134 may resemble the familiar surrounds of a residential home and may include portions that correspond to living areas of a residential home, such as a living room, kitchen, and/or bathroom. Or, there may be shared bathroom facilities on each floor of the facility 10 where multiple memorial suites 134 exist on a common floor. The memorial suite 134 may be a single room or several connected rooms, or it could be an entire floor of a building, or an entire building. The memorial suite 134 may be utilized as a family room, meeting room, community room, museum, or party room to share memories of the departed in an enhanced manner, utilizing multi-media technology such as audio, computerized and digital recordings, as well as artifacts, mementoes, photographs, and other associational histories in a private and environmentally-controlled and safe setting resembling a living room, den or other style room decided on by the owners of the memorial suite 134.

As shown in FIGS. 4-5, the memorial suite 134 is illustrated as a single room and includes an optional kitchen area having physical objects customarily found in a residential kitchen which may include but are not limited to a countertop 150 including a working sink 154 (FIG. 4) and a working stove top 158 (FIG. 4), a cabinet 162 with space for storing glassware, dishes, and kitchen utensils, and a table 166 surrounded by kitchen chairs 170. Other amenities such as for example a microwave oven or a conventional oven could be provided. In this manner, family members and loved ones of a decedent can prepare meals while visiting the memorial suite 134. One or more walls 174 of the memorial suite 134 may include wall hangings 178 such as photographs, portraits, or the like depicting an image of a decedent or a favorite object, place or memory to serve as a reminder of, or to pay tribute to one or more deceased family members. In addition, monitors, computers, electronic tablets and similar devices may be built into the walls or placed on tables or ledges to enable the storage and viewing or listening to written, graphic, video and sound records to inform visitors about the decedents; and Internet access would allow cloud storage of the data as well as access at the situs of the memorial suite, and remotely via the Internet or a network; and in addition there could be curated access to web sites that would be relevant to each decedent's lifestyle, values, beliefs, associations and biography to further inform the visitors about the decedents.

The memorial suite 134 may also include areas designed for comfort, meetings or to represent and revive memories or iconic aspects of the lives of the decedents. For example, a memorial suite could resemble a living room or family room, a lobby, salon, man cave, den, office, the interior of a boat, or other interior space decorated and arranged to resemble either a place that would be identified with the unique experiences and lives of the decedents or a specific theme. By way of further example, if the memorial suite 134 is designed to resemble a residential living room, it could be furnished with customary furnishings such as comfortable upholstered chairs 182 situated on opposite sides of a small table 186, rugs 190 of differing sizes and shapes, a sofa 194, a cocktail-height table 198, an end table 258, and decorative plantings 202. Alternatively, each memorial suite 134 may be provided with decorative flooring or carpeting. In addition, climate control and other comforts and amenities customarily found in a home could be provided within the memorial suite 134 to facilitate gatherings of mourners and friends. Each memorial suite 134 may be furnished with electrical power, heating, ventilation, cooling, air conditioning, plumbing, Wi-Fi connection and other comforts typically found in a home.

In addition, the memorial suite 134 may include other areas or rooms typically found in a residential home, e.g., a bathroom (not shown). In addition, the memorial suite 134 may include shelving 250, for example, in the form of book shelves which may be used for displaying memorabilia or mementoes 254 of one or more deceased family members. For example, a stamp collection (not shown) treasured by a departed family member could be displayed on the shelving 250 for viewing by surviving family members and friends to give survivors a better sense of the departed and their interests so as to evoke memories. Likewise, the shelving 250 could display a deceased family member's collection of books, hobbies, or musical instruments, tobacco pipes, etc. The shelving 250 could support a stereo system or similar device for playing music a deceased family member cherished during his or her lifetime. Likewise, a flat screen television (not shown) could be provided on the shelving 250 or mounted on a wall to display images or videos of a deceased family member during his or her life or other subject matter to evoke memories. The shelving 250 could also be utilized for displaying other items typically found in a living room or den of a home.

Referring to FIGS. 4-6, the memorial suite 134 also includes a storage area 206 for storing the remains of a decedent. The storage area 206 may be comprised of a plurality of generally horizontally oriented shelves including one or more upper shelves 210 and one or more lower shelves 214. The shelves 210 and 214 are provided to support one or more receptacles 218 situated thereon. As the interment needs of a family grows or needs change, additional receptacles 218 may be stored within the storage area 206. The memorial suite 134 and the storage area 206 are intended to be highly customizable, allowing for a method to adjust the interior space and for the storage area 206 to be reduced or enlarged depending on circumstances and needs. For example, a second storage area 206 could be added to accommodate more decedents than depicted in FIG. 4. As needs change, receptacles 218 may be added or removed from the storage area 206.

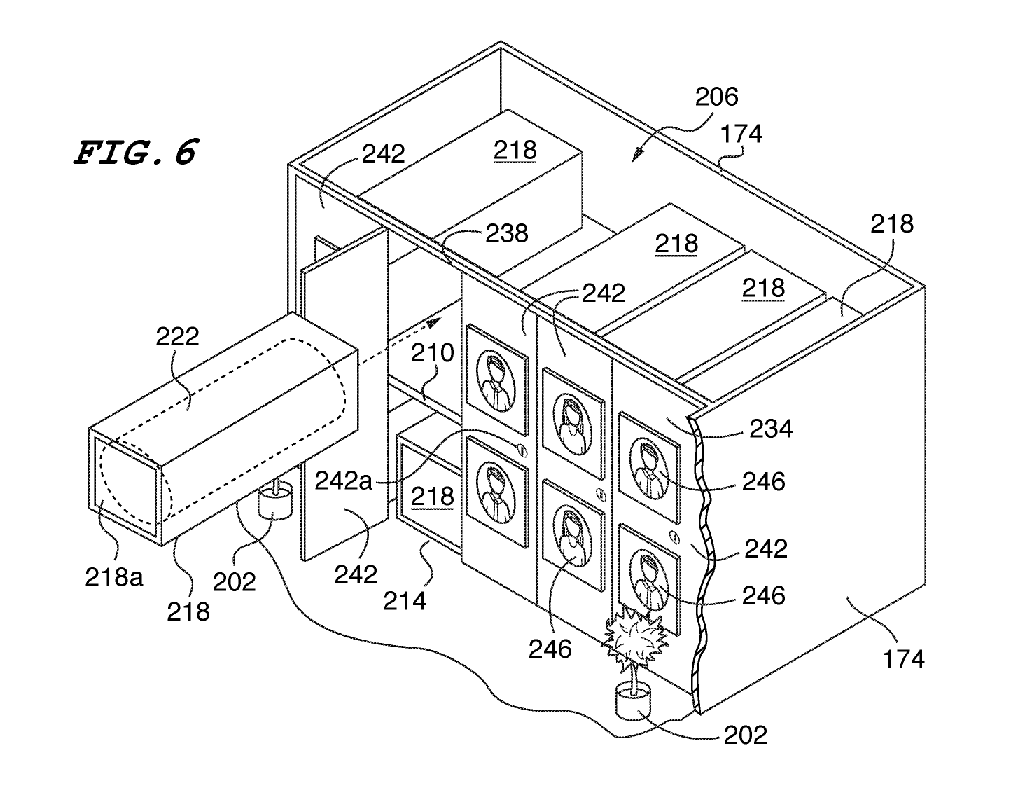

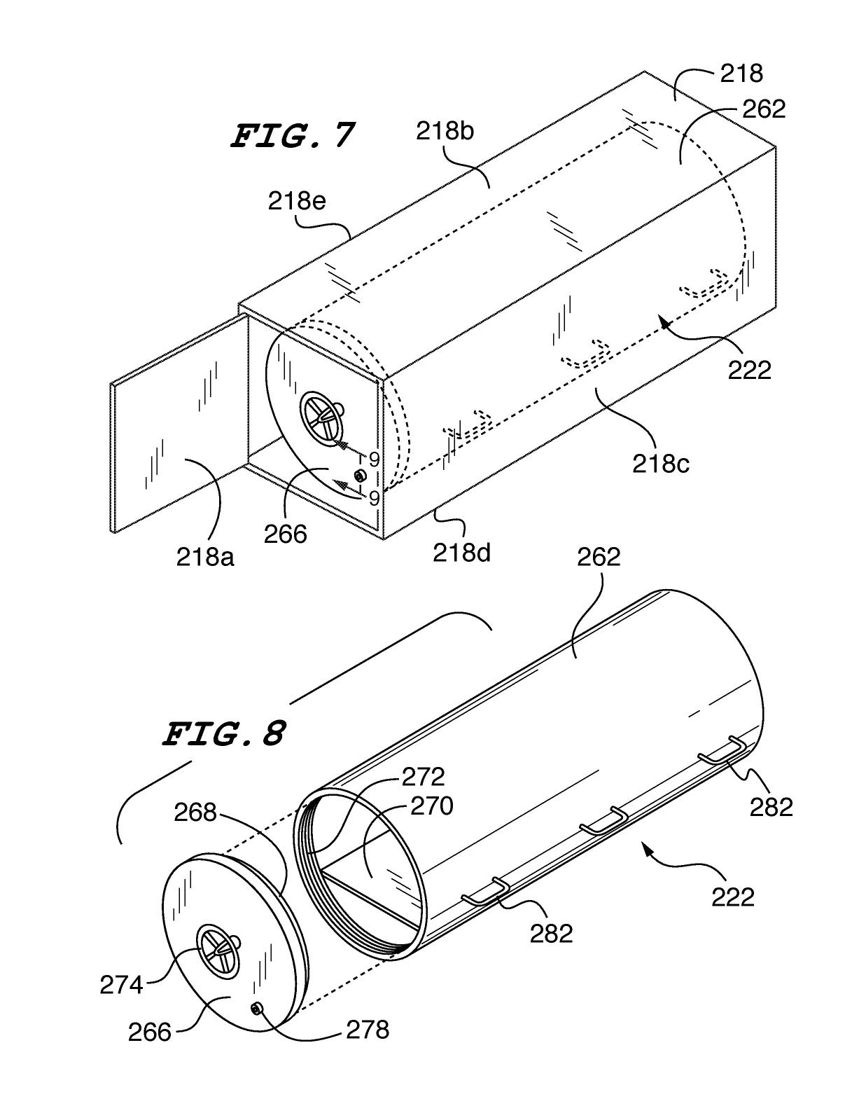

Each receptacle 218 is arranged for containing an interment vessel 222, discussed in detail below, containing the remains of a decedent. Alternatively, the receptacle 218 could be arranged for containing an air-tight, secure conventional casket (not shown). As best shown in FIG. 7, each receptacle 218 is in the shape of an elongated box that is formed of a front face 218a, a top face 218b, a bottom face 218c, side faces 218d and 218e, and a back face. The front face 218a is hingedly connected to the receptacle 218 and is arranged to swing between closed and opened positions. In FIG. 6, the front face 218a is in the closed position, and in FIG. 7, the front face 218a is shown in the opened position. In this manner, service personnel may open the front face 218a of the receptacle 218 to gain access to and remove a casket (not shown) or interment vessel 222 housed therein such as during a funeral or for transporting the casket (not shown) or interment vessel 222 to a new location in the event a family relocates. The front face 218a may be returned from the open position to the closed position once service personnel have removed the casket (not shown) or interment vessel 222 from the receptacle 218 or have finished placing the casket (not shown) or interment vessel 222 into the receptacle 218. Removing an interment vessel 222 from a memorial suite 134 during a family relocation is a major improvement over the prior art which would require unearthing a buried caskets which would then need to be cleaned off prior to transport, which would be expensive and disruptive.

As best shown in FIG. 6, in this example, storage area 206 includes a lower shelf 214 that is arranged for supporting five receptacles 218 and an upper shelf 210 that is arranged for supporting an additional five receptacles 218. By opening any of the doors 242, service personnel can obtain access to the receptacles 218 located on either the lower shelf 214 or the upper shelf 210. The number of receptacles shown is by way of example, and there is no set number except as may be dictated by the size and layout of the structure housing the memorial suites.

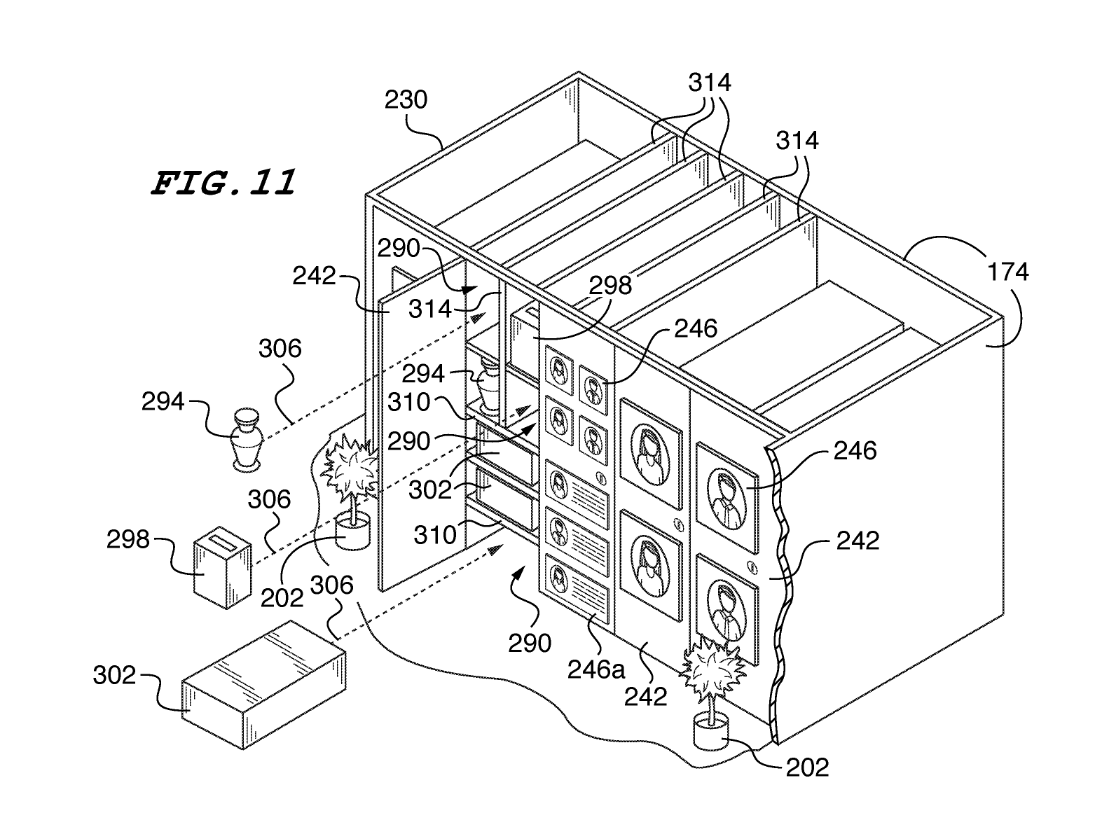

Referring now to FIG. 11 there is shown an alternative storage area 206, a portion of which is arranged for receiving containers of human remains, the containers being different than the receptacles 218 described above. Alternatively, the entire storage area 206 may be arranged for receiving such other containers. In particular, as shown in FIG. 11, the storage area 206 includes multiple storage compartments 290 of varying sizes to receive such other containers which may be of different sizes. Such other containers may include one or more cremation urns 294 for holding human ashes, one or more cremation boxes 298, larger in size than the cremation urns 294, but also arranged for holding human ashes, and one or more ossuary boxes 302 arranged for holding human skeletal remains. Arrows 306 illustrate storage compartments 290 appropriately sized for receiving such other containers, e.g., the urn 294, the cremation box 298, and the ossuary box 302. Each storage compartment 290 within the storage area 206 may be formed and sized as is needed utilizing appropriately dimensioned horizontal shelves 310 and vertical dividers 314 located in known ways within the storage area 206. Utilizing such shelves 310 and dividers 314, storage compartments 290 of other varying sizes may be created to suit different container sizes and space limitations. Additionally, as family needs change, existing compartments 290 may be increased or decreased in size by repositioning the horizontal shelves 310 and vertical dividers 314 in known ways. Such storage compartments may be arranged within a storage area 206 in combination with the shelves 210 and 214 for supporting the receptacles 218 previously discussed.

As best shown in FIG. 5, the storage area 206 may be situated at a discrete location within the memorial suite 134, such as at a corner therein where it is obscured from the view of grieving family members and visitors. As shown in FIG. 5, the storage area 206 is located in a corner of the memorial suite 134 where it is surrounded by walls including a partition wall 230, a tribute wall 234, and walls 174 of the memorial suite 134 itself. In particular, the tribute wall 234, the partition wall 230, and the walls 174 serve to hide the receptacles 218 from view of family members and visitors during visits to the memorial suite 134.

As best shown in FIG. 6, the tribute wall 234 includes a metal frame 238, e.g., steel or aluminum frame, with multiple, e.g., five, locking doors 242 hingedly mounted thereto, the locking doors 242 being arranged to swing between closed and opened positions. A lock on each door 242 is indicated at 242a. In this manner, service personnel may unlock the doors 242 to gain access to the receptacles 218 located within the storage area 206 for removal of an receptacle containing a casket (not shown), interment vessel 222, a cremation urn 294, a cremation box 298, or an ossuary box 302 stored therein. Such removal may be for the purpose of a funeral or memorial service, or for transport of such containers to a new location in the event the family relocates to a new city or town.

The tribute wall 234 may be adorned with one or more plaques 246 bearing an image of a decedent whose remains are contained within a casket (not shown), interment vessel 222, cremation urn 294, a cremation box 298, or ossuary box 302. The casket, interment vessel 222, cremation urn 294, a cremation box 298, or ossuary box 302 may be located at a position that corresponds with the location of the plaque 246. Alternatively, or in addition, as best shown in FIG. 11, the plaque 246 may include descriptive information about the decedent, such as a brief statement commemorating, or paying tribute to her life, as indicated at 246a in FIG. 11.

The memorial suite 134 is designed to celebrate the life of the decedent and teach friends and family members about the decedent in a positive and uplifting environment. In an embodiment, the memorial suite 134 may include one or more devices (not shown) linked via an internet connection to a website or the previously mentioned online application (such as for smart phones or smart tablets) dedicated to the decedent being memorialized and containing information about the decedent, such as obituary information and/or a memorial page with digitized text, photos, videos, and other information, such as friends' comments and the like. The website or online application would be a members-only, private and secure application, available only to the deceased (while alive) and his/her selected family, friends or acquaintances. In this way, facility 10 clients can prepare a journal while living, containing favorite quotes, journal entries, videos, photos and other content they wish their family, friends and acquaintances to have access to after their death. The intent is, using this website or online application, family, friends and acquaintances can access the account while at home or at remote locations other than the facility 10. This website or application account would be included as part of the cost of buying a memorial suite 134, but may also be made available for a premium to non-suite holders. The website or application may also integrate with automated autobiographical tools such as Facebook® (Facebook Inc. of Palo Alto, Calif., at www.facebook.com) and other social networking sites to tell the story or narrative of the life of the decedent through text and images. Alternatively, the client or family members could arrange to have those stories made available on a computer situated within the memorial suite 134. If the memorial suite 134 is used as a place to inter deceased members of a military or other associational group, the same principles would apply, but the emphasis would be modified by the theme of the association.

Similar to apartments within an apartment building, or rooms within a hotel, access to each memorial suite 134 is provided from a common hallway (not shown) through a door (not shown) which can be locked. Each floor within the multi-floor building 14 may house one or several memorial suites 134. The building 14 in which the memorial suites 134 are situated may be provided in the style of a multi-tenant apartment building or a hotel having common areas and amenities customarily found in such places such as common hallways, elevators, restrooms, waste removal facilities, elevator lobbies, stairwells, heating, air conditioning, plumbing, electrical service, etc.

The multi-unit facility 10 could be arranged as a condominium type of real estate wherein each memorial suite 134 within the complex is individually owned, each owner receiving a recordable deed to the individual unit purchased, including the right to sell, mortgage, etc., that memorial suite 134. Also, individual spaces within the storage area 206 may be purchased, allowing family members or significant others to co-own the memorial suite 134. Potentially, certain memorial suites 134 may be set aside for sharing between people or families who do not know each other, and do not mind sharing the memorial suite 134. The common grounds such as hallways, parking, heating, electricity, maintenance, and other common areas identified above, may be jointly owned and managed collectively by the owners through an association, similar to a homeowner association.

Each memorial suite 134 may be owned by an individual or family unit wishing to be interred together in a shared private area away from the viewing public. The memorial suite 134 could be purchased by the individual or family unit and may include sufficient interment space for immediate family members as well as future needed interment space for additional family members and heirs including relatives, children, and grandchildren and even invited friends as future needs arise. Ownership may be as a condominium or similar type of real estate division. Each memorial suite 134 could be a single room or several connected rooms. A memorial suite 134 may be sold to a new buyer and the original owner can remove the receptacles and other containers to make room for those belonging to the new owner. In addition, the owner of a memorial suite 134, like the owner of a condominium unit can sublease, or partition a portion of the memorial suite to one or more tenants or buyers. As a result, unlike a grave, the memorial suite should have a market value that could appreciate, and provide economic opportunities, and value if in the future, due to relocation of the family, or the need to raise funds, the owners do not want to retain ownership of the memorial suite 134.

Referring now to FIGS. 7-8, there is shown an receptacle 218 containing an interment vessel 222 arranged to house a corpse (not shown) of a decedent. The interment vessel 222 may be made of a light-weight and durable material such as aluminum and may be air-tight to prevent escape of odors, gases or fluids associated with decay. In this manner, the interment vessel 222 may be used for easily transporting the corpse for use at a funeral and then returning to the memorial suite 134 for housing within the storage area 206 after use.

As the interment vessel 222 is cylindrical in shape and lighter in weight than a traditional wood or metal casket which includes a hingedly connected lid, the interment vessel 222 provides a higher degree of transportability of corpses than conventional caskets. Due to its size, shape and weight, the interment vessel 222 may be conveniently placed within a large automobile, such as a sport utility vehicle (“SUV”), an airplane, or a train. As the interment vessel 222 is cylindrical in shape, it is innocuous in appearance in that it does not resemble a traditional casket. In this manner, it can be transported by family members without concern that onlookers will know the true nature of the contents of the interment vessel 222. In addition, once the interment vessel 222 reaches its destination, it may be easily lifted from the vehicle and placed in another memorial suite 134 located in a town to which a family has relocated. Alternatively, the interment vessel 222 may be buried in the ground of a cemetery located in such a town.

The interment vessel 222 includes a sidewall 262 and an end wall (not shown) defining a cavity therein and an end cap 266. The sidewall 262 may be generally cylindrical in shape. Situated within the cavity is a horizontally situated platform 270 (FIG. 8) on which the corpse (not shown) of the decedent may be placed for storage. Alternatively, the horizontally situated platform 270 and the interment vessel 222 may be sized and arranged to support a casket (not shown) containing the corpse of a decedent to obscure the casket from view during transport. The end cap 266 is generally disk-shaped and may be provided with an external thread 268 to enable tight threaded engagement with internal threads 272 located on the sidewall 262 of the interment vessel 222. The end cap 266 is also provided with a spoked wheel 274 which can be hand rotated to enable tight threaded engagement of the end cap 266 with the sidewall 262. The spoked wheel 274 enables tight attachment of the end cap 266 to the sidewall 262 of the interment vessel 222 to form an airtight seal for keeping ambient air and moisture out of the interment vessel 222 and for containing odor-causing gases and fluids associated with decay within the interment vessel 222. This manner of attachment of the end cap 266 to the body 262 is a clear advancement over the traditional casket which is merely a box-shaped vessel with a lid that is hingedly attached at one end only. Due to this manner of tight attachment, the interment vessel 222 of the present invention is better suited for long-distance shipping by any suitable means such as by airplane, train, or truck. This is in comparison to the traditional casket which is not suited for such long-distance transport.

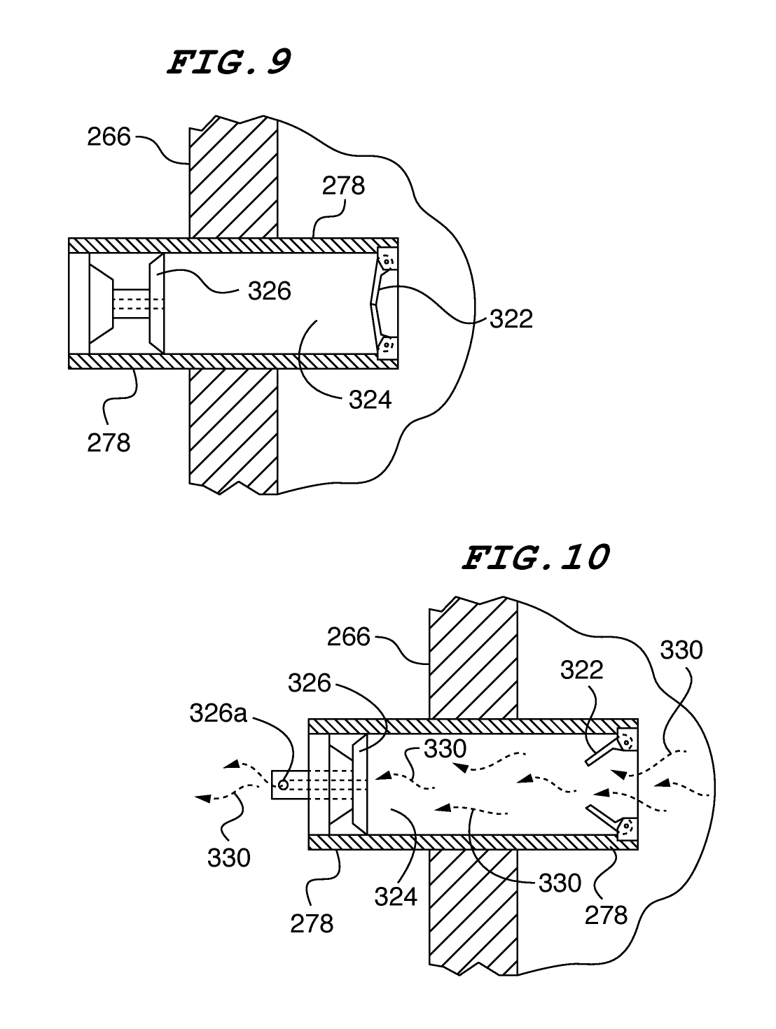

Referring now to FIGS. 9 and 10, the interment vessel 222 is provided with a one-way check valve 278. The one-way check valve 278 includes an interior valve portion 322 located on the interior side of the end cap 266, an exterior valve portion 326 located on the exterior side of the end cap 266, and a passageway 324 located between the valve portions 322 and 326. As best shown in FIG. 9, the interior and exterior valve portions 322, 326 are each spring-loaded so that each is biased to a closed position. As best shown in FIG. 10, each valve portion 322, 326 is arranged to move from the closed position to an open position. Referring again to FIG. 9, while the interior valve portion 322 and exterior valve portion 326 are disposed in the normally closed position, an external vacuum source (not shown) may be connected to the exterior valve portion 326 in known ways. Once connected, the external vacuum source (not shown) may be activated to cause the interior and exterior valve portions 322 and 326 to move from their normally closed positions (FIG. 9) to their open positions (FIG. 10) to permit evacuation of air (indicated at arrows 330) from within the cavity of the interment vessel 222, through the passageway 324 and out to the atmosphere through valve opening 326a, to create a vacuum within the interment vessel 222.

Upon disconnecting the vacuum source (not shown) from the exterior valve portion 326, the interior and exterior valve portions 322, 326 will instantaneously return from the open position (FIG. 10) to the normally closed position (FIG. 9) to prevent ambient air and moisture from entering the interment vessel 222 and to maintain a vacuum therein.

The occurrence of explosion of conventional caskets due to a buildup of trapped gases from a decomposing corpse, also known as exploding casket syndrome, is a known occurrence. Even conventional caskets made of metal can leak as the result of such pressure buildup. Such explosions, which result in hinges becoming detached from the casket, can result in the spilling out of toxic gases and fluids trapped inside the casket. When a casket explodes in above-ground mausoleums, it can create unpleasant and potentially hazardous conditions for visitors and the environment. In some cases, once such an explosion occurs, the corpse contained therein may be completely liquefied and unsuitable for re-burial.

Likewise, as a corpse housed within the sealed interment vessel 222 of the present invention naturally decomposes, odor-causing gases and fluids accumulate. By providing a cylindrical-shaped sidewall 262 and a threaded type of engagement between the end cap 266 and the sidewall 262 in combination with the vacuum described above, the interment vessel 222 of the present invention is well-suited to withstand the buildup of trapped gases and avoid the above-described exploding casket syndrome. The one-way check valve 278 is operable to allow for the escape of such accumulated gases, as indicated at arrows 330, from within the interment vessel 222 upon pressure therein exceeding a predetermined threshold. In particular, upon pressure reaching such a predetermined threshold, the interior and exterior valve portions 322 and 326 move from the normally closed position (FIG. 9) to the open position (FIG. 10) to permit the escape of accumulated gases to reduce pressure within the cavity to a level below the predetermined threshold. The traditional casket, which is a box-shaped vessel that includes a lid that is attached by one or more hinges is more likely to leak or even pop open in response to accumulated decomposition gases. The interment vessel 222 is provided with handles 282 disposed on the sidewall 262 to enable transport of the interment vessel 222 by service personnel.

The memorial suite 134, receptacle 218, interment vessel 222, and other containers, e.g., cremation urn 294, cremation box 298, and ossuary box 302, provide portability, ease of use, and return on investment. For example, a family may have purchased a memorial suite 134 within a multi-floor building 14 and utilized that memorial suite 134 for storing interment vessels 222 or other containers, e.g., cremation urn 294, cremation box 298, and ossuary box 302. In the event the surviving family decides to move away from their home town to a new city or town, the family could sell the memorial suite 134 or a portion of the storage area 206. Based upon market conditions, the selling price could be significantly above the original purchase price, resulting in a premium. The receptacles 218, interment vessels 222 and/or other containers, e.g., cremation urn 294, cremation box 298, and ossuary box 302 could readily be removed from the storage area 206 and transported to a new memorial suite 134 purchased by the family and located in proximity to the town to which the family moves. Alternatively, in the event there is no memorial suite 134 in proximity to the new town, the interment vessels 222 or other containers 294, 298 and 302 could be buried in the ground. Or, the deceased's remains could be removed from the interment vessel 222 and cremated or prepared for an ossuary, to be interred in the same memorial suite 134 or at a different location.

I claim:

1. A memorial suite providing a private, safe and comfortable place for surviving family members, friends, and loved ones to mourn, research and visit decedents and providing storage for the remains of the decedents, said memorial suite comprising:
a. a floor, a ceiling, and a plurality of walls defining a continuous interior space;
b. a storage area located within a first portion of said continuous interior space, said storage area comprising a horizontal shelf;
c. a container for human remains supported on said horizontal shelf;
d. a living area located within a second portion of said continuous interior space; and,
e. a vertically-oriented tribute wall separating said storage area from said living area, said tribute wall including a door hingedly mounted thereto and adapted to move between closed and opened positions to enable access to and removal of said container for human remains from within said storage area by service personnel.

2. The memorial suite of claim 1, additionally comprising a receptacle supported on said horizontal shelf, and wherein said container for human remains comprises an interment vessel housed within said receptacle.

3. The memorial suite of claim 1, wherein said container for human remains comprises a cremation urn.

4. The memorial suite of claim 1, wherein said container for human remains comprises an ossuary box.

5. The memorial suite of claim 2, wherein said receptacle is in the shape of an elongated box.

6. The memorial suite of claim 2, wherein said interment vessel is arranged for housing a casket containing a decedent's remains.

7. The memorial suite of claim 1, additionally comprising a receptacle supported on said horizontal shelf, and wherein said container for human remains comprises a casket housed within said receptacle.

8. The memorial suite of claim 2, wherein said receptacle includes a front face hingedly attached thereto and arranged to swing between closed and open positions to permit access within said receptacle.

9. The memorial suite of claim 1, wherein said living area includes a plurality of adjoining rooms.

10. The memorial suite of claim 1, wherein said living area includes a kitchen.

11. The memorial suite of claim 10, wherein said living area includes a bathroom.

12. The memorial suite of claim 10, wherein said living area includes a living room.

13. The memorial suite of claim 1, wherein said door includes a door-locking device.

14. The memorial suite of claim 2, wherein said horizontal shelf comprises a plurality of horizontal shelves and wherein said receptacle comprises a plurality of receptacles arranged in an array of horizontal rows and vertical columns supported on said plurality of horizontal shelves.

15. The memorial suite of claim 14, wherein said array comprises two horizontal rows and five vertical columns.

16. The memorial suite of claim 14, wherein said door comprises a plurality of doors aligned with the vertical columns of said array.

17. The memorial suite of claim 1, wherein when said door is in the closed position, said tribute wall is arranged to conceal said storage area from view of family and friends situated in said living area.

18. The memorial suite of claim 1, wherein said tribute wall includes at least one plaque bearing the image of a decedent whose remains are contained within said storage area.

19. The memorial suite of claim 18, wherein said at least one plaque bears descriptive information about a decedent whose remains are contained within said storage area.

20. The memorial suite of claim 1, additionally comprising shelving located within said living area, said shelving provided for supporting mementoes and photographs of a decedent whose remains are contained within said interment chamber.

21. The memorial suite of claim 1, wherein said storage area is situated in a corner of said continuous interior space, and additionally comprising a partition wall situated generally perpendicular to said tribute wall to create an enclosure surrounding said storage area.

22. The memorial suite of claim 1, wherein said memorial suite is furnished with heating, air conditioning, electrical power and plumbing.

23. A building structure comprising a ground floor, multiple upper floors situated above said ground floor, and at least one memorial suite located on any of said multiple upper floors, said memorial suite providing a private, safe and comfortable place for surviving family members, friends, and loved ones to mourn, research and visit decedents and providing storage for the remains of the decedents, said memorial suite comprising:
a. a floor, a ceiling, and a plurality of walls defining a continuous interior space;
b. a storage area located within a first portion of said continuous interior space, said storage area comprising a horizontal shelf;
c. a container for human remains supported on said horizontal shelf;
d. a living area located within a second portion of said continuous interior space; and,
e. a vertically-oriented tribute wall separating said storage area from said living area, said tribute wall including a door hingedly mounted thereto and adapted to move between closed and opened positions to enable access to and removal of said container for human remains from within said storage area by service personnel.

24. The building structure of claim 23, additionally comprising a receptacle supported on said horizontal shelf, and wherein said container for human remains comprises an interment vessel housed within said receptacle.

25. The building structure of claim 23, wherein said container for human remains comprises a cremation urn.

26. The building structure of claim 23, wherein said container for human remains comprises an ossuary box.

27. The building structure of claim 23, wherein said at least one memorial suite comprises two or more memorial suites located on any one of said multiple upper floors.

28. The building structure of claim 23, wherein said ground floor includes a common area.

29. The building structure of claim 28, wherein said common area includes a funeral parlor.

30. The building structure of claim 28, wherein said common area includes a lobby area.

31. The building structure of claim 28, wherein said common area includes administrative and security offices.

32. The building structure of claim 28, wherein said common area includes a flower and gift shop.

33. The building structure of claim 28, wherein said common area includes a café.

34. The building structure of claim 28, wherein said common area includes storage facilities.

35. The building structure of claim 23, additionally comprising a parking lot surrounding said building structure.

36. The building structure of claim 35, additionally comprising a security gate and guard house surrounding said parking lot to control ingress and egress thereto.

37. The building structure of claim 23, wherein said building structure is arranged as a condominium type of real estate wherein each said memorial suite is individually owned and wherein said common area is jointly owned and managed collectively through a condominium association.

38. The building structure of claim 23, wherein each said memorial suite located therein is provided with an internet connection providing access to a website or online application dedicated to one or more decedents being memorialized.

39. The building structure of claim 24, wherein said horizontal shelf comprises a plurality of horizontal shelves and wherein said receptacle comprises a plurality of receptacles arranged in an array of horizontal rows and vertical columns supported on said plurality of horizontal shelves, and wherein each receptacle houses the remains of decedents sharing a common affinity.

40. The building structure of claim 39, wherein said common affinity is that said decedents fought in a particular war or battle.

41. The building structure of claim 39, wherein said common affinity is that said decedents were first responders to an emergency and killed in the line of duty.

42. An interment vessel arranged for containing the remains of a decedent which provides increased transportability, and is well-suited for use in permanent burial as well as temporary storage, said interment vessel comprising:
a. a body having an open end, a closed end, and being generally cylindrical in shape;
b. an end cap arranged to be threadedly affixed to the open end of said body;
c. a platform affixed within said body, said platform extending substantially the length of said body;
d. a locking mechanism disposed on said end cap to affix said end cap to the open end of said body to create a seal; and,
e. a one-way check valve disposed on said end cap and operable to maintain a vacuum within said interment vessel and to prevent entry therein of ambient air and moisture, and to allow for the escape of gases from within said interment vessel when pressure therein exceeds a predetermined threshold.

43. The interment vessel of claim 42, wherein said platform is arranged for supporting the remains of a decedent thereon.

44. The interment vessel of claim 42, wherein said interment vessel is formed of a light-weight and durable material.

45. The interment vessel of claim 44, where said interment vessel is formed of aluminum.

46. The interment vessel of claim 42, wherein said end cap is generally disk-shaped.

47. The interment vessel of claim 42, additionally comprising a plurality of handles to enable transportation of said receptacle by service personnel.

48. An interment vessel arranged for containing the remains of a decedent which provides increased transportability, and is well-suited for use in permanent burial as well as temporary storage, said interment vessel comprising:
a. a body having an open end, a closed end, and a configuration and appearance dissimilar to that of a traditional casket to facilitate transportability utilizing a conventional automobile rather than a hearse;
b. an end cap arranged to be threadedly affixed to the open end of said body;
c. a platform affixed within said body, said platform extending substantially the length of said body and arranged for receiving the remains of a decedent thereon; and,
d. a locking mechanism disposed on said end cap to affix said end cap to the open end of said body to create a seal.
